(19) United States
(12) Patent Application Publication
(10) Pub. No.: US 2012/0274433 A1
(43) Pub. Date: Nov. 1, 2012

(54) COIL COMPONENT

(75) Inventors: Tsuyoshi MATSUMOTO, Takasaki-shi (JP); Hidenori AOKI, Takasaki-shi (JP); Hideki OGAWA, Takasaki-shi (JP); Takuya WATANABE, Takasaki-shi (JP)

(73) Assignee: TAIYO YUDEN CO., LTD., Tokyo (JP)

(21) Appl. No.: 13/422,862

(22) Filed: Mar. 16, 2012

(30) Foreign Application Priority Data
Apr. 28, 2011 (JP) 2011-100513

(51) Int. Cl. H01F 27/29

(52) U.S. Cl. 336/192

(57) ABSTRACT

A coil component has a magnetic core made of magnetic alloy, a coil having a spiral part placed around a pillar part of the magnetic core, a magnetic sheath formed on the magnetic core in a manner covering the coil except for the bottom face of the magnetic core, and a first external terminal and a second external terminal formed on the magnetic core and magnetic sheath, where the parts of the magnetic sheath covering the areas around the spiral part of the coil are thicker than the parts covering the top face of the spiral part.

### BACKGROUND

1. Field of the Invention

The present invention relates to a coil component of surface mounting type having a structure of a coil placed around the pillar part of a magnetic core.

2. Description of the Related Art

With coil components of surface mounting type having a structure of a coil placed around the pillar part of a magnetic core, such as inductors and choke coils, attempts are being made to change the material of the magnetic core to a magnetic alloy having a higher magnetic permeability than conventional ferrite (magnetic ceramics) in order to answer the demand for larger current in recent years.

A magnetic core made of magnetic alloy is produced by die-shaping a magnetic paste containing magnetic alloy grains and then applying heat to the shaped paste. However, it is difficult to achieve sintering effect similar to what is expected with a magnetic core made of ferrite, even when heat is applied, and consequently a magnetic core made of magnetic alloy tends to be inferior to a conventional magnetic core made of ferrite in terms of the bending strength of the magnetic core itself.

### PATENT LITERATURES

[Patent Literature 1] Japanese Patent Laid-open No. 2010-034102

### SUMMARY

The object of the present invention is to provide a coil component using a magnetic core made of magnetic alloy, wherein such coil component can ensure bending strength equivalent to or better than that of a conventional coil component using a magnetic core made of ferrite.

To achieve the aforementioned object, the present invention (coil component) comprises:

a magnetic core integrally having a sheet part and a pillar part formed on the top face of the sheet part and made of a magnetic alloy;

a pair of first conductive films formed from the side face to bottom face of the sheet part of the magnetic core;

a coil integrally having a spiral part where a conductive wire is spirally wound, and one end of the conductive wire and other end of the conductive wire drawn from the spiral part, where the spiral part is placed around the pillar part of the magnetic core, and the one end of the conductive wire is joined to the one first conductive film, while the other end of the conductive wire is joined to the other first conductive film;

a magnetic sheath formed in such a way as to cover the top face of the pillar part and side face of the sheet part of the magnetic core, surfaces of the side faces of the one and other first conductive films, and surfaces of the spiral part, one end of the conductive wire and joined part at the one end of the conductive wire, as well as other end of the conductive wire and joined part at the other end of the conductive wire, of the coil;

a pair of second conductive films formed from the side face of the magnetic sheath to the bottom face of the sheet part of the magnetic core, via the bottom face of the magnetic sheath, in such a way that the surfaces of the bottom faces of the one and other first conductive films are covered, respectively; and

a pair of third conductive films formed in such a way as to cover the surfaces of the one and other second conductive films;

wherein the one first conductive film, one second conductive film and one third conductive film constitute a first external terminal, while the other first conductive film, other second conductive film and other third conductive film constitute a second external terminal; and

wherein the parts of the magnetic sheath covering the areas around the spiral part of the coil are thicker than the parts covering the top face of the spiral part.

According to the present invention, the magnetic sheath not only covers the top face and surroundings of the coil, but it also covers the top face of the pillar part and side face of the sheet part, of the magnetic core, and additionally the parts covering the areas around the spiral part are thicker than the parts covering the top face of the spiral part, and because of these features, especially due to the presence of the thicker parts covering the areas around the spiral part, the bending resistance of the magnetic core, especially the bending resistance of the outer peripheries of the sheet part, can be improved to enhance the bending strength of the coil component as a whole. This prevents cracking of the magnetic core due to thermal expansion and contraction of the coil component caused by an external force received when the coil component is installed on a circuit board, etc., or when reflow soldering is performed, cracking of the magnetic core due to thermal expansion and contraction of the mounted coil component, and other problems, to improve the reliability of the coil component.

The aforementioned purpose and other purposes, constitutions/characteristics and operations/effects of the present invention are revealed by the following explanations and attached drawings.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a perspective external view of a coil component to which the present invention is applied (Embodiment 1).

FIG. 2 is an enlarged section view of the coil component shown in FIG. 1, cut along line S1-S1.

FIG. 3 is an enlarged section view of the coil component shown in FIG. 1, cut along line S2-S2.

FIG. 4 is an enlarged bottom view of the coil component shown in FIG. 1.

FIG. 5 is a schematic view of a grain condition of the magnetic core shown in FIGS. 2 to 4, according to an image obtained by observing the core with a transmission electron microscope.

FIG. 6 is a section view, corresponding to FIG. 2, of a coil component to which the present invention is applied (Embodiment 2).

### DESCRIPTION OF SYMBOLS

10—Coil component
11—Magnetic core
11a—Sheet part
11b—Pillar part
12, 13—First conductive film
14, 14′—Coil
14a—Spiral part
14b—One end of conductive wire
14c—Other end of conductive wire
15—Magnetic sheath
16, 17—Second conductive film
18, 19—Third conductive film
ET1—First external terminal
ET2—Second external terminal

### DETAILED DESCRIPTION

### Embodiment 1

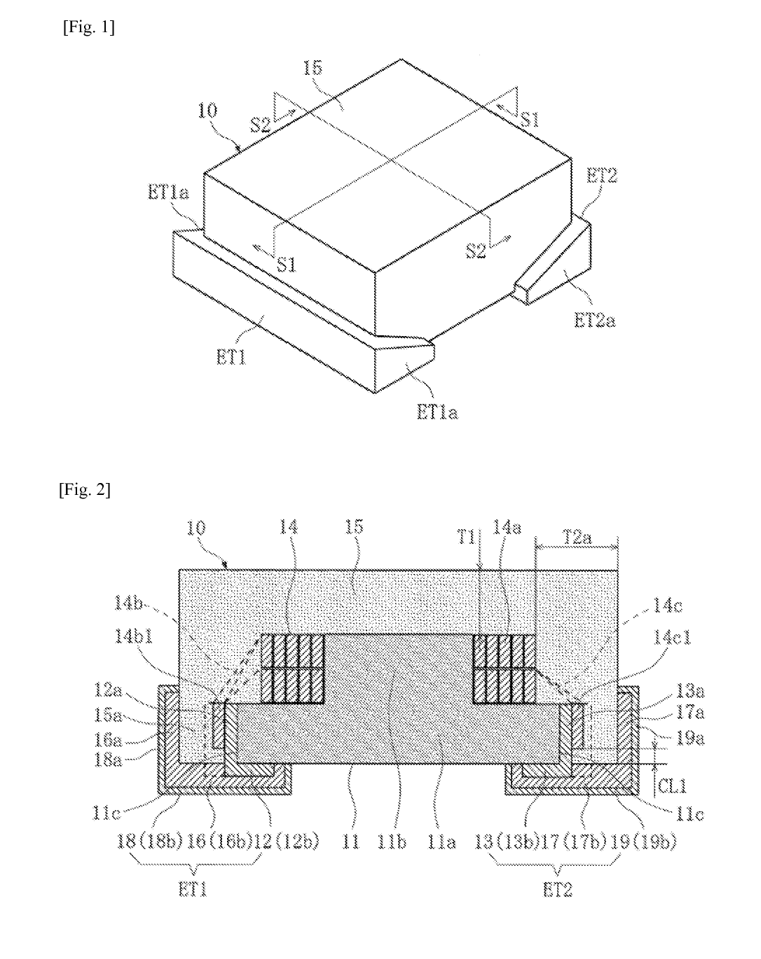

FIGS. 1 to 5 show a coil component 10 to which the present invention is applied (Embodiment 1). For the purpose of explanation, top, bottom, left, right, front and rear of FIG. 2 are referred to as top, bottom, front, rear, left and right, respectively, and the same applies to the corresponding directions of FIGS. 1, 3 and 4.

<Structure of Coil Component 10>

The coil component 10 shown in FIGS. 1 to 4 has a magnetic core 11, a pair of first conductive films 12, 13, a coil 14, a magnetic sheath 15, a pair of second conductive films 16, 17, and a pair of third conductive films 18, 19. The size of this coil component 10 is, for example, 2.5 mm in front-rear dimension, 2.0 mm in left-right dimension, and 1.0 mm in top-bottom dimension.

The magnetic core 11 integrally has a sheet part 11a having a profile in bottom view of a rough rectangle as well as a specific thickness (such as 0.24 mm when the top-bottom dimension is 1.0 mm), and a pillar part 11b provided on the top face of the sheet part 11a and having a profile in top view of a rough oval as well as a specific height. Also, a concaved part 11c whose profile in top view forms a rough trapezoid shape is formed roughly at the centers of the front face and rear face of the sheet part 11a, respectively. The height of the pillar part 11b with reference to the top face of the sheet part 11a is roughly the same as the height of the spiral part 14a of the coil 14.

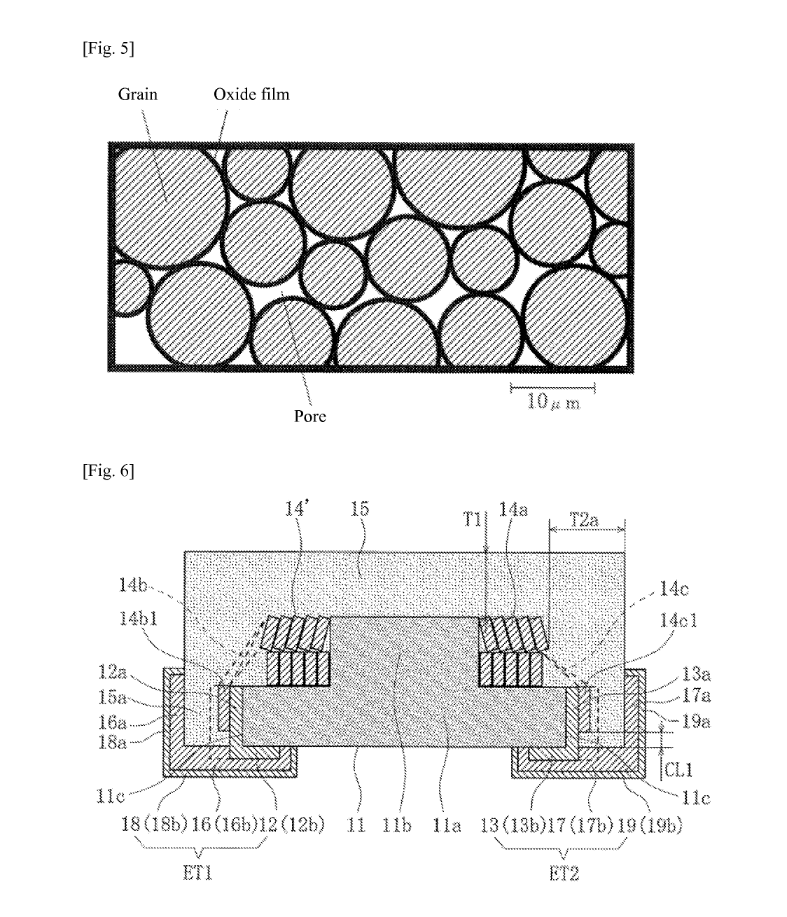

This magnetic core 11 is made of a magnetic alloy. To be specific, as shown in FIG. 5, it is constituted by magnetic alloy grains having an oxide film (=insulation film) formed on their surface and bonding together via the oxide film, and this oxide film ensures insulation between adjacent magnetic alloy grains. To describe the production method, etc., the magnetic core 11 is formed by die-shaping a magnetic paste containing magnetic alloy grains, solvent and binder at a specific mass ratio, and then heat-treating the shaped paste in an oxidizing atmosphere to remove the solvent and binder. An oxide film is formed on the surface of each magnetic alloy grain in the heat treatment process, and in the heat treatment process the solvent and binder are also removed and pores are present between magnetic alloy grains with an oxide film formed on the surface. The magnetic alloy grain is preferably a Fe—Cr—Si alloy, Fe—Si—Al alloy, Fe—Ni—Cr alloy, etc., where a desired d50 (median diameter) of the magnetic alloy grain by volume is 3 to 20 μm, while a desired content of magnetic alloy grains in magnetic paste is 85 to 95 percent by weight.

FIG. 5 schematically represents a grain condition of the magnetic core 11, according to an image obtained by observing it with a transmission electron microscope, after creating the magnetic core 11 using Fe—Cr—Si alloy grains whose d50 (median diameter) is 10 μm. Each magnetic alloy grain does not actually form a perfect sphere, but all magnetic alloy grains are depicted as spheres to express that grain diameters are distributed. In addition, while the thickness of the oxide film present on the surface of each magnetic alloy grain varies in a range of 0.05 to 0.2 μm, all grains are depicted as having a uniform thickness to express that the oxide film is present on the surface of each magnetic alloy grain. It should be noted, it has been confirmed that, if the magnetic alloy grain is a Fe—Cr—Si alloy grain, the oxide film contains Fe₃O₄ being a magnetic body as well as FeO₃ and Cr₂O₃ being non-magnetic bodies.

Note that, while the aforementioned oxide film was obtained by oxidizing elements contained in magnetic alloy grains in the heat treatment process, a substance that would produce an oxide film in the heat treatment process may be added to the magnetic paste beforehand, or a glass component that would produce an insulation film similar to oxide film in the heat treatment process may be added to the magnetic paste beforehand.

The first conductive film 12 on the front side is formed from the front face (including the inner face of the concaved part 11c) of the sheet part 11a of the magnetic core 11 to the front part of the bottom face of the sheet part 11a, and also to the front parts of the left and right faces of the sheet part 11a. The first conductive film 13 on the rear side is formed from the rear face (including the inner face of the concaved part 11c) of the sheet part 11a of the magnetic core 11 to the rear part of the bottom face of the sheet part 11a, and also to the rear parts of the left and right faces of the sheet part 11a.

To describe the production method, etc., the first conductive films 12, 13 are formed by applying a conductive paste containing metal grains, solvent and binder at a specific mass ratio, in a manner covering the specified locations of the sheet part 11a of the magnetic core 11, and then baking the conductive paste to remove the solvent and binder. The metal grain is preferably an Ag or Pd grain, etc., where a desired d50 (median diameter) of the metal grain by volume is 3 to 20 μm, while a desired content of metal grains in conductive paste is 85 to 95 percent by weight.

In other words, since the first conductive films 12, 13 are baked conductive films offering excellent heat resistance that do not contain resin component, etc., any subsequent heat treatment (for example, heat treatment applied when the one end 14b of the conductive wire or the other end 14c of the conductive wire is joined, heat treatment applied when the magnetic sheath 15 is created, or heat treatment applied when the second conductive films 16, 17 are created) will not cause degradation, position shift or other changes to the first conductive films 12, 13 during the heat treatment and good adhesion between the first conductive films 12, 13 and magnetic core 11 can also be maintained.

The coil 14 integrally has a spiral part 14a where a conductive wire is spirally wound, and one end 14b of the conductive wire and the other end 14c of the conductive wire are drawn from the spiral part 14a. The conductive wire used for the coil 14 is a so-called rectangular wire (conductive wire whose cross-section shape is a rectangle having long sides and short sides), and the spiral part 14a is wound by winding in the flat-wise direction. Preferably the conductive wire comprises a Cu, Ag or other metal wire (Cu is desirable from the viewpoint of costs) and an insulation film covering the metal wire, or a conductive wire comprising a metal wire, an insulation film covering the metal wire and a heat-seal film covering the insulation film (interconnecting the conductive wires constituting the spiral part 14a) can also be used, among others.

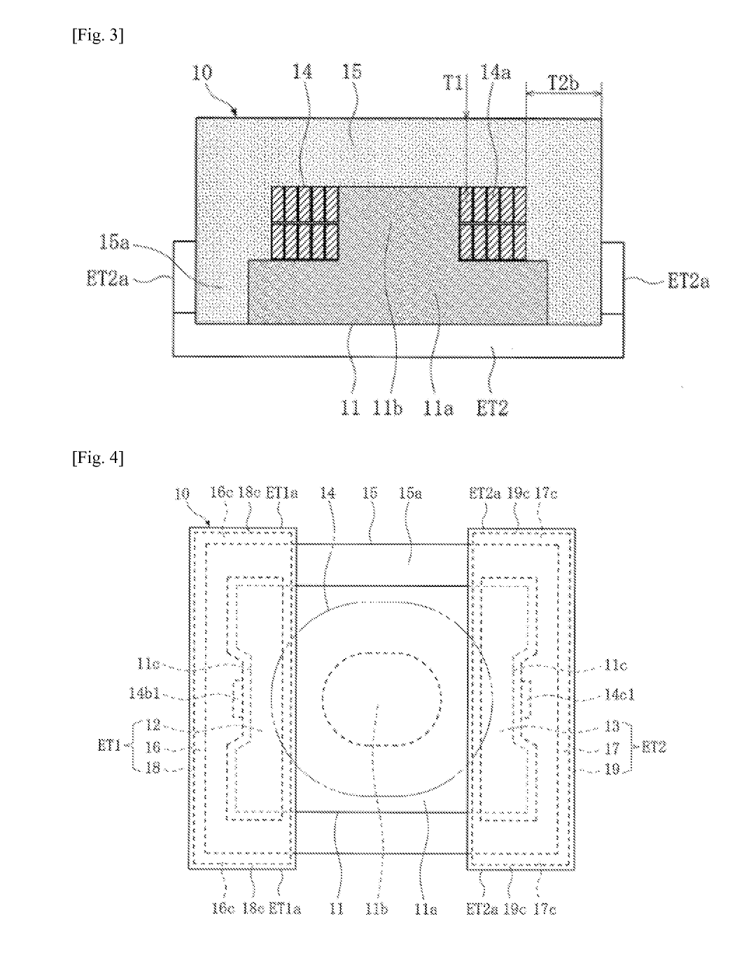

The spiral part 14a is placed around the pillar part 11b of the magnetic core 11, where the placement method includes directly winding the conductive wire around the pillar part 11b to form the spiral part 14a, or creating the coil 14 separately and fitting the spiral part 14a into the pillar part 11b. Since the height of the pillar part 11b of the magnetic core 11 (height of the pillar part 11b with reference to the top face of the sheet part 11a) is roughly the same as the height of the spiral part 14a, the top face of the spiral part 14a after the placement becomes roughly flush with the top face of the pillar part 11b of the magnetic core 11, as shown in FIGS. 2 and 3. Also at the tip of the one end 14b of the conductive wire, the insulation layer and heat-seal layer covering the tip are removed and then the surface on the long side is electrically joined to roughly the center of the surface of the side face 12a of the first conductive film 12 on the front side (position corresponding to roughly the center of the inner face of the concaved part 11c) via diffusion bonding (heat-seal joining). Furthermore at the tip of the other end 14c of the conductive wire, the insulation layer and heat-seal layer covering the tip are removed and then the surface on the long side is electrically joined to roughly the center of the surface of the side face 13a of the first conductive film 13 on the rear side (position corresponding to roughly the center of the inner face of the concaved part 11c) via diffusion bonding (heat-seal joining).

The top-bottom dimension of the joined part 14b1 at the one end 14b of the conductive wire and top-bottom dimension of the joined part 14c1 at the other end 14c of the conductive wire may be the same as the thickness of the sheet part 11a of the magnetic core 11, but as shown in FIG. 2, it is better to provide a clearance CL1 between the bottom edges of joined parts 14b1, 14c1 and bottom face of the sheet part 11a because then an area where a part of the magnetic sheath 15 has wrapped around can be formed below the joined parts 14b1, 14c1. Note that the number of windings of the spiral part 14a and cross-section area of the metal wire constituting the conductive wire are specified, as appropriate, according to the inductance, rated current and other characteristic values required of the coil component 10.

As mentioned above, the first conductive films 12, 13 are baked conductive films offering excellent heat resistance, so any heat treatment that may be applied when the one end 14b of the conductive wire or the other end 14c of the conductive wire is joined will not cause degradation, position shift or other changes to the first conductive films 12, 13 during the heat treatment and the first conductive films 12, 13 and the one end 14b of the conductive wire or the other end 14c of the conductive wire can be joined in a favorable manner.

The magnetic sheath 15 has a profile in top view of a rough rectangle and is formed in such a way as to cover the top face of the pillar part 11b and front and rear faces and left and right faces (side faces) of the sheet part 11a, of the magnetic core 11, surfaces of the side faces 12a, 13a of the first conductive films 12, 13, and surfaces of the spiral part 14a, one end 14b of the conductive wire and joined part 14b1 at the one end 14b of the conductive wire, as well as other end 14c of the conductive wire and joined part 14c1 at the other end 14c of the conductive wire, of the coil 14, and the bottom face of the sheath is roughly flush with the bottom face of the pillar part 11b of the magnetic core 11.

Also, as shown in FIGS. 2 and 3, the parts of the magnetic sheath 15 covering the top face of the spiral part 14a of the coil 14 have a specified thickness T1. Since the top face of the spiral part 14a of the coil 14 is roughly flush with the top face of the pillar part 11b of the magnetic core 11, the thickness of the parts of the magnetic sheath 15 covering the top face of the pillar pat 11b is roughly the same as the thickness T1. On the other hand, the parts of the magnetic sheath 15 covering the front and rear sides of the spiral part 14a of the coil 14 have a specified thickness T2a, while the parts of the magnetic sheath 15 covering the left and right sides of the spiral part 14a of the coil 14 have a specified thickness T2b, and these thicknesses T2a and T2b are greater than the thickness T1. Since the profile in top view of the magnetic sheath 15 is a rough rectangle, needless to say the thickness of the parts of the magnetic sheath 15 covering areas other than the left and right sides and front and rear sides of the spiral part 14a of the coil 14 is also greater than the thickness T1. In essence, the thicknesses (T2a, T2b) of the parts of the magnetic sheath 15 covering the areas around the spiral part 14a of the coil 14 are greater than the thickness (T1) of the parts of the magnetic sheath 15 covering the top face of the spiral part 14a of the coil 14. To give examples of specific values, if the thickness (T1) of the parts of the magnetic sheath 15 covering the top face of the spiral part 14a of the coil 14 is 200 μm, then the thicknesses (T2a, T2b) of the parts covering the areas around the spiral part 14a of the coil 14 are 240 to 500 μm.

This magnetic sheath 15 is constituted by magnetic alloy grains and insulation material present between magnetic alloy grains, where this insulation material ensures bonding of adjacent magnetic alloy grains as well as insulation between these adjacent magnetic alloy grains. To describe the production method, etc., the magnetic sheath 15 is formed by die-shaping a magnetic paste containing magnetic alloy grains and thermo-setting insulation material at a specific mass ratio, while inserting a magnetic core 11 (to which a coil 14 has been installed) into the die in a manner allowing for the coverings mentioned above, and then heat-treating the shaped paste to harden the insulation material. The magnetic alloy grain is preferably a Fe—Cr—Si alloy, Fe—Si—Al alloy or Fe—Ni—Cr alloy, etc., where a desired d50 (median diameter) of the magnetic alloy grain by volume is 3 to 20 μm, while a desired content of magnetic alloy grains in magnetic paste is 85 to 95 percent by weight. Also, for the thermo-setting insulation material, epoxy resin, phenol resin, polyester, etc., is a desired choice.

In other words, since the magnetic sheath 15 contains an insulation material constituted by epoxy resin, etc., sufficient adhesion with the magnetic core 11, first conductive films 12, 13 and coil 14 can be ensured by this insulation material.

The second conductive film 16 on the front side is formed from the bottom of the front face of the magnetic sheath 15 to the front part of the bottom face of the sheet part 11a of the magnetic core 11 via the bottom face of the magnetic sheath 15, and also to the front parts of the left and right faces of the magnetic sheath 15, in a manner covering the surface of the bottom face 12b of the first conductive film 12 on the front side and being electrically connected to the bottom face 12b. The second conductive film 17 on the rear side is formed from the bottom part of the rear face of the magnetic sheath 15 to the rear part of the bottom face of the sheet part 11a of the magnetic core 11 via the bottom face of the magnetic sheath 15, and also to the rear parts of the left and right faces of the magnetic sheath 15, in a manner covering the surface of the bottom face 13b of the first conductive film 13 on the rear side and being electrically connected to the bottom face 13b. Additionally, the top-edge heights of the side faces 16a, 17a of the second conductive films 16, 17 are slightly higher than the top-face height of the sheet part 11a of the magnetic core 11. Also, the side face 16a and bottom face 16b of the second conductive film 16 on the front side are connected via the second side faces 16c present on the left face and right face of the magnetic sheath 15, respectively, while the side face 17a and bottom face 17b of the second conductive film 17 on the rear side are connected via the second side faces 17c present on the left face and right face of the magnetic sheath 15, respectively.

The second conductive films 16, 17 are constituted by metal grains and an insulation material present between metal grains, where some metal grains contained in the second conductive film 16 on the front side are contacting the surface of the bottom face 12b of the first conductive film 12 on the front side, while some metal grains contained in the second conductive film 17 on the rear side are contacting the surface of the bottom face 13b of the first conductive film 13 on the rear side. To describe the production method, etc., the second conductive films 16, 17 are formed by applying a conductive paste containing metal grains and thermo-setting insulation material at a specific mass ratio, in a manner covering the specified locations of the magnetic sheath 15 and magnetic core 11 and also the bottom faces 12b, 13b of the first conductive films 12, 13, and then heat-treating the applied paste to harden the insulation material. The metal grain is preferably an Ag or Pd grain, etc., where a desired d50 (median diameter) of the metal grain by volume is 3 to 20 μm, while a desired content of metal grains in conductive paste is 80 to 90 percent by weight. Also, for the thermo-setting insulation material, epoxy resin, phenol resin, polyester, etc., is a desired choice.

In other words, since the second conductive films 16, 17 contain an insulation material constituted by epoxy resin, etc., sufficient adhesion with the magnetic sheath 15, first conductive films 12, 13 and magnetic core 11 can be ensured by this insulation material. Also because the second conductive films 16, 17 have a high content of metal grains, high conductivity can be achieved.

The third conductive film 18 on the front side is formed in a manner covering the surface of the second conductive film 16 on the front side, has a side face 18a corresponding to the side face 16a of the second conductive film 16 on the front side, a bottom face 18b corresponding to the bottom face 16b of the same, and a second side face 18c corresponding to the second side face 16c of the same, and is electrically connected to the second conductive film 16 on the front side. The third conductive film 19 on the rear side is formed in a manner covering the surface of the second conductive film 17 on the rear side, has a side face 19a corresponding to the side face 17a of the second conductive film 17 on the rear side, a bottom face 19b corresponding to the bottom face 17b of the same, and a second side face 19c corresponding to the second side face 17c of the same, and is electrically connected to the second conductive film 17 on the rear side.

To describe the production method, etc., the third conductive films 18, 19 are formed on the surfaces of the second conductive films 16, 17 by electroplating or other thin-film forming method. A desirable mode of the third conductive films 18, 19 is a two-layer structure comprising a Ni film and a Sn film covering the surface of the Ni film, but the number of layers and materials constituting the layers are not specifically limited as long as connection to the second conductive films 17, 18 can be made in a favorable manner and the coil component 10 can be mounted on a circuit board, etc., or specifically soldered to a connection pad, in a favorable manner.

With this coil component 10, the first conductive film 12 on the front side, second conductive film 16 on the front side and third conductive film 18 on the front side constitute a first external terminal ET1, while the first conductive film 13 on the rear side, second conductive film 17 on the rear side and third conductive film 19 on the rear side constitute a second external terminal ET2. In addition, the second side face 16c of the second conductive film 16 on the front side and second side face 18c of the third conductive film 18 on the front side constitute two wraparound parts ET1a on the first external terminal ET1, while the second side face 17c of the second conductive film 17 on the rear side and second side face 19c of the third conductive film 19 on the rear side constitute two wraparound parts ET2a on the second external terminal ET2.

Also with this coil component 10, the joined part 14b1 at the one end 14b of the conductive wire of the coil 14 is sandwiched by the side face 12a of the first conductive film 12 on the front side and a part 15a of the magnetic sheath 15 covering the side face of the sheet part 11a of the magnetic core 11, and furthermore a part (no reference numeral) of the magnetic sheath 15 covering the surface of the joined part 14b1 at the one end 14b of the conductive wire of the coil 14 is sandwiched, with the joined part 14b1 in between, by the side face 12a of the first conductive film 12 on the front side and side face 16a of the second conductive film 16 on the front side as well as side face 18a of the third conductive film 18 on the front side. In addition, the joined part 14c1 at the other end 14c of the conductive wire of the coil 14 is sandwiched by the side face 13a of the first conductive film 13 on the rear side and part 15a of the magnetic sheath 15 covering the side face of the sheet part 11a of the magnetic core 11, and furthermore a part (no reference numeral) of the magnetic sheath 15 covering the surface of the joined part 14c1 at the other end 14c of the conductive wire of the coil 14 is sandwiched, with the joined part 14c1 in between, by the side face 13a of the first conductive film 13 on the rear side and side face 17a of the second conductive film 17 on the rear side as well as side face 19a of the third conductive film 19 on the rear side.

<Example of Favorable Method for Manufacturing Coil Component 10>

First, for the magnetic core 11, a magnetic paste containing 85 percent by weight of Fe—Cr—Si alloy grains whose d50 (median diameter) is 10 μm, 13 percent by weight of butyl carbitol (solvent) and 2 percent by weight of polyvinyl butyral (binder) is prepared, and this magnetic paste is shaped using dies and a press machine, after which the shaped paste is heat-treated for 2 hours in an atmosphere of 750° C. to remove the solvent and binder, while an oxide film of magnetic alloy grain is formed on the surface of each magnetic alloy grain, to create the magnetic core 11.

Next, for the first conductive films 12, 13, a conductive paste containing 85 percent by weight of Ag grains whose d50 (median diameter) is 5 μm, 13 percent by weight of butyl carbitol (solvent) and 2 percent by weight of polyvinyl butyral (binder) is prepared, and this conductive paste is applied to the magnetic core 11 using a roller coater, after which the applied paste is baked for 1 hour in an atmosphere of 650° C. to remove the solvent and binder, to create the first conductive films 12, 13.

Next, a conductive wire (rectangular wire) for coil 14 is directly wound around the pillar part 11b of the magnetic core 11 in the flat-wise direction according to the alpha winding method to form a spiral part 14a, and the tip (where the insulation layer and heat-seal layer have been removed) of one end 14b of the conductive wire is joined to the surface of the side face 12a of the first conductive film 12 on the front side via diffusion bonding (heat-seal joining), while the tip (where the insulation layer and heat-seal layer have been removed) of the other end 14c of the conductive wire is joined to the surface of the side face 13a of the first conductive film 13 on the rear side via diffusion bonding (heat-seal joining).

Next, for the magnetic sheath 15, a magnetic paste containing 90 percent by weight of Fe—Cr—Si alloy grains whose d50 (median diameter) is 10 μm and 10 percent by weight of epoxy resin is prepared, and this magnetic paste is shaped using dies and a press machine for the magnetic core 11 where the coil 14 is placed, after which the shaped paste is heat-treated for 1 hour in an atmosphere of 180° C. to harden the epoxy resin, to create the magnetic sheath 15.

Next, for the second conductive films 16, 17, a conductive paste containing 80 percent by weight of Ag grains whose d50 (median diameter) is 5 μm and 20 percent by weight of epoxy resin is prepared, and this conductive paste is applied to the magnetic core 11 and magnetic sheath 15 using a roller coater, after which the applied paste is heat-treated for 1 hour at 150° C. to harden the epoxy resin, to create the second conductive films 16, 17.

Next, the created second conductive films 16, 17 are introduced to a Ni electroplating bath to form a Ni film on the surface of second conductive films 16, 17, after which the Ni-covered films are introduced to a Sn electroplating bath to form a Sn film on the surface of each Ni film, to create the third conductive films 18, 19.

<Effects of Coil Component 10>

(Effect 1) With this coil component 10, the magnetic sheath 15 covers not only the top face and surroundings of the coil 14 but also the top face of the pillar part 11b and side face of the sheet part 11a, of the magnetic core 11, and also the parts covering the areas around the spiral part 14a of the coil 14 are thicker than the parts covering the top face of the spiral part 14a, and because of these features, especially due to the presence of the thicker parts covering the areas around the spiral part 14a, the bending resistance of the magnetic core 11, especially the bending resistance of the outer peripheries of the sheet part 11a, can be improved to enhance the bending strength of the coil component 10 as a whole. This prevents cracking of the magnetic core 11 due to thermal expansion and contraction of the coil component 10 caused by an external force received when the coil component 10 is installed on a circuit board, etc., or when reflow soldering is performed, cracking of the magnetic core 11 due to thermal expansion and contraction of the mounted coil component 10, and other problems, to improve the reliability of the coil component 10.

(Effect 2) With this coil component 10, since the parts of the magnetic sheath 15 covering the areas around the spiral part 14a of the coil 14 are thicker than the parts covering the top face of the spiral part 14a, the magnetic flux flowing in the magnetic sheath 15 can be effectively prevented from leaking from the peripheral surfaces of the magnetic sheath 15. Accordingly, even when an electronic component is mounted in a close proximity to the coil component 10 in a circuit board, etc., characteristic deterioration, etc., of that electronic component due to the influence of the magnetic flux leaking from the peripheral surfaces of the magnetic sheath 15 of the coil component 10 can be avoided.

(Effect 3) With this coil component 10, since the thickness of the parts of the magnetic sheath 15 covering the top face of the spiral part 14a of the coil 14 is roughly the same as the thickness of the parts of the magnetic sheath 15 covering the top face of the pillar part 11b of the magnetic core 11, the magnetic flux flow in the magnetic sheath 15, or specifically inductance of the coil component 10, can easily be adjusted by simply changing the thickness of the parts covering the top face of the spiral part 14a of the coil 14 and thickness of the parts covering the areas around the spiral part 14a, and also the balance of the two thicknesses.

### Embodiment 2

FIG. 6 shows a coil component to which the present invention is applied (Embodiment 2). This coil component is structurally different from the coil component 10 in Embodiment 1 in that the conductive wire constituting the spiral part 14a of a coil 14′ is partially inclined. Other parts of the structure are the same as those of the coil component 10 in Embodiment 1 and therefore not explained.

In the drawing, the conductive wire in the upper stage of the spiral part 14a is inclined. However, the above phrase “partially inclined” includes cases where, among others, only the conductive wire in the upper stage of the spiral part 14a is partially inclined, conductive wire in the upper stage and conductive wire in the lower stage, of the spiral part 14a, are partially inclined, and conductive wire in the lower stage of the spiral part 14a is partially inclined.

With this coil component, the inclination of conductive wire(s) causes the thickness T2a of the parts of the magnetic sheath 15 covering the front and rear sides of the spiral part 14a of the coil 14′, thickness T2b of the parts covering the left and right sides of the spiral part 14a, and thickness of the parts covering the areas other than the left and right sides and front and rear sides of the spiral part 14a, to effectively decrease compared to Embodiment 1. However, even with the spiral part 14a having the aforementioned mode, (Effect 1) to (Effect 3) described above can be achieved in a similar manner as long as the thicknesses (T2a, T2b) of the areas of the magnetic sheath 15 covering the areas around the spiral part 14a of the coil 14 are greater than the thickness (T1) of the parts of the magnetic sheath 15 covering the top face of the spiral part 14a of the coil 14′.

### OTHER EMBODIMENTS

(1) In Embodiments 1 and 2, rectangular wires were used as the conductive wires for coils 14, 14′ and the coils 14, 14′ were wound in the spiral part 14a by a winding in the flat-wise direction. However, the winding direction in the spiral part 14a may be the edge-wise direction, winding method in the spiral part 14a may be other than a winding, and conductive wires other than rectangular wires (such as round wires) may be used for coils 14, 14′. In essence, effects similar to those described above can be achieved even when the cross-section shape, winding direction and winding method of the conductive wires for coils 14, 14′ are changed.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. In this disclosure, any defined meanings do not necessarily exclude ordinary and customary meanings in some embodiments. Also, in this disclosure, “the invention” or “the present invention” refers to one or more of the embodiments or aspects explicitly, necessarily, or inherently disclosed herein.

The present application claims priority to Japanese Patent Application No. 2011-100513, filed Apr. 28, 2011, the disclosure of which is incorporated herein by reference in its entirety. In some embodiments, as the magnetic core, those disclosed in U.S. Patent Application Publication No. 2011/0267167 A1 and No. 2012/0038449, and co-assigned U.S. patent application Ser. No. 13/313,982 can be used, each disclosure of which is incorporated herein by reference in its entirety. In some embodiments, as the magnetic sheath, those disclosed in co-assigned U.S. patent application Ser. No. 13/399,794 can be used, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We claim:

1. A coil component comprising:
a magnetic core integrally made of a magnetic alloy and having a sheet part and a pillar part formed on a top face of the sheet part;
a pair of first conductive films formed from a side face to bottom face of the sheet part of the magnetic core;
a coil integrally having a spiral part where a conductive wire is spirally wound, and one end of the conductive wire and other end of the conductive wire drawn from the spiral part, where the spiral part is placed around the pillar part of the magnetic core, and the one end of the conductive wire is joined to the one first conductive film, while the other end of the conductive wire is joined to the other first conductive film;
a magnetic sheath formed so as to cover a top face of the pillar part and the side face of the sheet part of the magnetic core, surfaces of side faces of the one and other first conductive films, and surfaces of the spiral part, one end of the conductive wire and joined part at the one end of the conductive wire, as well as other end of the conductive wire and joined part at the other end of the conductive wire, of the coil;
a pair of second conductive films formed from a side face of the magnetic sheath to the bottom face of the sheet part of the magnetic core, via a bottom face of the magnetic sheath, in such a way that surfaces of bottom faces of the one and other first conductive films are covered, respectively; and
a pair of third conductive films formed in such a way as to cover surfaces of the one and other second conductive films;
wherein the one first conductive film, one second conductive film and one third conductive film constitute a first external terminal, while the other first conductive film, other second conductive film and other third conductive film constitute a second external terminal; and
wherein parts of the magnetic sheath covering areas around the spiral part of the coil have a horizontal thickness defined as a distance from the side face of the spiral part of the coil to the side face of the sheath along a direction passing through the first and second external terminals and a center of the magnetic core as viewed from above and perpendicular to a height direction of the pillar part of the magnetic core, and parts of the magnetic sheath covering the top face of the spiral part of the coil have a vertical thickness defined as a distance from the top face of the spiral part of the coil to the top face of the sheath along the height direction of the pillar part of the magnetic core, wherein the horizontal thickness is greater than the vertical thickness.

2. A coil component according to claim 1, wherein the thickness of the parts of the magnetic sheath covering the top face of the spiral part of the coil is roughly the same as the thickness of the parts of the magnetic sheath covering the top face of the pillar part of the magnetic core.

3. A coil component according to claim 1, wherein the magnetic core is constituted by magnetic alloy grains having an oxide film formed on their surfaces and interconnected via the oxide film.

4. A coil component according to claim 2, wherein the magnetic core is constituted by magnetic alloy grains having an oxide film formed on their surfaces and interconnected via the oxide film.

5. A coil component according to claim 1, wherein the conductive wire is a flat wire and spirally wound around the pillar part of the magnetic core in the flat-wise direction according to the alpha winding method to form the spiral part.

6. A coil component according to claim 5, wherein the spiral part is comprised of an upper stage and a lower stage, and the conductive wire in the upper stage has bottom edges of each wind farther away from the pillar part than are bottom edges of each wind so as to be inclined, as viewed in a vertical cross section, relative to the conductive wire in the lower stage.
